(19) United States
(12) Patent Application Publication
(10) Pub. No.: US 2008/0143644 A1
(43) Pub. Date: Jun. 19, 2008

(54) Plasma display device and driving method thereof

(76) Inventor: Jin-Boo Son, Yongin-si (KR)

Correspondence Address: CHRISTIE, PARKER & HALE, LLP, PO BOX 7068, PASADENA, CA, 91109-7068, US

(21) Appl. No.: 11/983,614

(22) Filed: Nov. 9, 2007

(30) Foreign Application Priority Data
Dec. 18, 2006 (KR) 10-2006-0129404

(51) Int. Cl. G09G 3/28

(52) U.S. Cl. 345/60

(57) ABSTRACT

A plasma display device and its driving method are disclosed. The plasma display device includes a plasma display panel (PDP) including a plurality of first and second electrodes. The plasma display device further includes a first power source for supplying a first voltage; a second power source for supplying a second voltage having a lower voltage level than the first voltage; a third power source for supplying a third voltage; a first transistor having a first terminal electrically connected with the plurality of first electrodes and a second terminal electrically connected with the first power source; a second transistor having a first terminal electrically connected with the plurality of first electrodes and a second terminal electrically connected with the second power source; and a first resistor having a first end electrically connected with the plurality of first electrodes and a second end electrically connected with the third power source.

### CROSS-REFERENCE TO RELATED APPLICATION

This application claims priority to and the benefit of Korean Patent Application No. 10-2006-0129404 filed in the Korean Intellectual Property Office on Dec. 18, 2006, the entire content of which is incorporated herein by reference.

### BACKGROUND OF THE INVENTION

1. Field of the Invention

The present invention relates to a plasma display device and its driving method.

2. Description of the Related Art

A plasma display device is a flat panel display for displaying characters or images by using plasma generated according to a gas discharge. In a plasma display panel (PDP) of the plasma display device, hundreds of thousands to millions of discharge cells are arranged in a matrix form according to its size.

In general, in the plasma display device, voltage is charged in a capacitor connected with a plurality of power sources, and then, when each switch electrically connected between a panel capacitor and a power source is turned on, the voltage charged in the capacitor connected with the power source is applied to the panel capacitor.

The capacitor connected with the power source is a capacitive element with large capacity, so when the power source is turned off as a driving of the plasma display device is terminated, the voltage charged in the capacitor connected with the power source should be completely discharged. Unless the capacitor connected with the power source is properly discharged, a risk for an electric shock would increase due to the voltage remaining in the capacitor and a surge current may be generated to damage elements, etc.

Accordingly, when the power source is turned off as the driving of the plasma display device is terminated, a certain amount of energy is slowly and naturally discharged by the panel capacitor. In this case, the increase in a size of the panel would have more energy, so time for discharging increases. If a set is turned on in a state that energy of the panel has not been completely discharged, namely, if the set is turned on at an early stage, sharp potential change may be generated at a main path terminal. This may cause malfunction of a switch.

The above information disclosed in this Background section is only for enhancement of understanding of the background of the invention and therefore it may contain information that does not form the prior art that is already known in this country to a person of ordinary skill in the art.

### SUMMARY OF THE INVENTION

In exemplary embodiments according to the present invention, a plasma display device has features of stably discharging electric charges remaining in a capacitor connected with a power source by using a discharge resistor after power of the plasma display device is turned off, and reducing or minimizing an unnecessary defect that may be generated when the capacitor connected with the power source is charged.

An exemplary embodiment of the present invention provides a plasma display device including a plasma display panel (PDP) including a plurality of first and second electrodes. The plasma display device includes a first power source for supplying a first voltage; a second power source for supplying a second voltage having a lower voltage level than the first voltage; a third power source for supplying a third voltage; a first transistor having a first terminal electrically connected with the plurality of first electrodes and a second terminal electrically connected with the first power source; a second transistor having a first terminal electrically connected with the plurality of first electrodes and a second terminal electrically connected with the second power source; and a resistor having a first end electrically connected with the plurality of first electrodes and a second end electrically connected with the third power source. When power of the plasma display device is turned off, a discharge path including the resistor may be formed. When the plasma display device is turned off, the first and second transistors may be turned off, and the first electrodes, the resistor and the third power source may be electrically connected in series to form the discharge path. The first voltage may have substantially the same voltage level as that of a sustain discharge pulse applied to the first electrodes during a sustain period. The plasma display device may further include a fourth power source for supplying a fourth voltage having a higher voltage level than the second voltage; and a third transistor electrically connected between the fourth power source and the plurality of first electrodes. The second and third voltages may be ground voltages. The fourth voltage may have substantially the same voltage level as a bias voltage applied to the first electrodes during a falling period of a reset period and an address period.

Another embodiment of the present invention provides a plasma display device including a plasma display panel (PDP) including a plurality of first and second electrodes. The plasma display device includes: a first power source for supplying a first voltage; a second power source for supplying a second voltage having a lower voltage level than the first voltage; a third power source for supplying a third voltage; a first transistor having a first terminal electrically connected with the plurality of first electrodes and a second terminal electrically connected with the first power source; a second transistor having a first terminal electrically connected with the plurality of first electrodes and a second terminal electrically connected with the second power source; an inductor having a first end electrically connected with the plurality of first electrodes; and a resistor having a first end electrically connected with the inductor and a second end electrically connected with the third power source. When power of the plasma display device is turned off, a discharge path including the resistor may be formed. When power of the plasma display device is turned off, the first and second transistors may be turned off, and the first electrodes, the inductor, the resistor and the third power source may be electrically connected in series to form the discharge path. The first voltage may have substantially the same voltage level as that of a sustain discharge pulse applied to the first electrodes during a sustain period. The plasma display device may further include a fourth power source for supplying a fourth voltage having a higher voltage level than the second voltage and a third transistor electrically connected between the fourth power source and the plurality of first electrodes. The fourth voltage may have substantially the same voltage level as a bias voltage applied to the first electrodes during a falling period of a reset period and an address period. The plasma display device may further include: a first diode electrically connected with a second end of the inductor and the first end of the resistor; a second diode electrically connected with the second end of the inductor and the first end of the resistor; a fourth transistor having a first terminal electrically connected with the first diode; a fifth transistor having a second terminal electrically connected with the second diode; a capacitor having a first terminal electrically connected with a second terminal of the fourth transistor and a first terminal of the fifth transistor; and a fifth power source electrically connected with a second terminal of the capacitor, wherein the fifth power source may be adapted to supply a fifth voltage. The second, third and fifth voltages may be ground voltages.

Yet another embodiment of the present invention provides a method for driving a plasma display device including a plurality of first electrodes, a plurality of second electrodes corresponding to the first electrodes, and a resistor having a first end electrically connected with the plurality of first electrodes and a second end electrically connected to a power source. The method for driving the plasma display device includes: forming a discharge path through the first electrodes, the resistor, and the power source that are electrically connected after power of the plasma display device is turned off. The plasma display device may further include an inductor electrically connected between the first electrodes and the resistor, and said forming a discharge path may include: forming the discharge path through the first electrodes, the inductor, the resistor, and the power source that are electrically connected.

### BRIEF DESCRIPTION OF THE DRAWINGS

FIG. 1 is a schematic block diagram showing a plasma display device according to an exemplary embodiment of the present invention.

FIG. 2 is a waveform diagram illustrating driving waveforms of the plasma display device according to the exemplary embodiment of the present invention.

FIG. 3 is a circuit diagram of a sustain electrode driver 500 in FIG. 1 according to a first exemplary embodiment of the present invention.

FIG. 4 is a circuit diagram illustrating a driving operation of a driving circuit in FIG. 3 after power of the plasma display device is turned off according to the first exemplary embodiment.

FIG. 5 is circuit diagram of a sustain electrode driver according to a second exemplary embodiment of the present invention.

FIG. 6 is a circuit diagram illustrating a driving operation of a driving circuit in FIG. 5 after power of the plasma display device is turned off according to the second exemplary embodiment.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

The plasma display device and its driving apparatus according to the exemplary embodiment of the present invention will now be described with reference to the accompanying drawings.

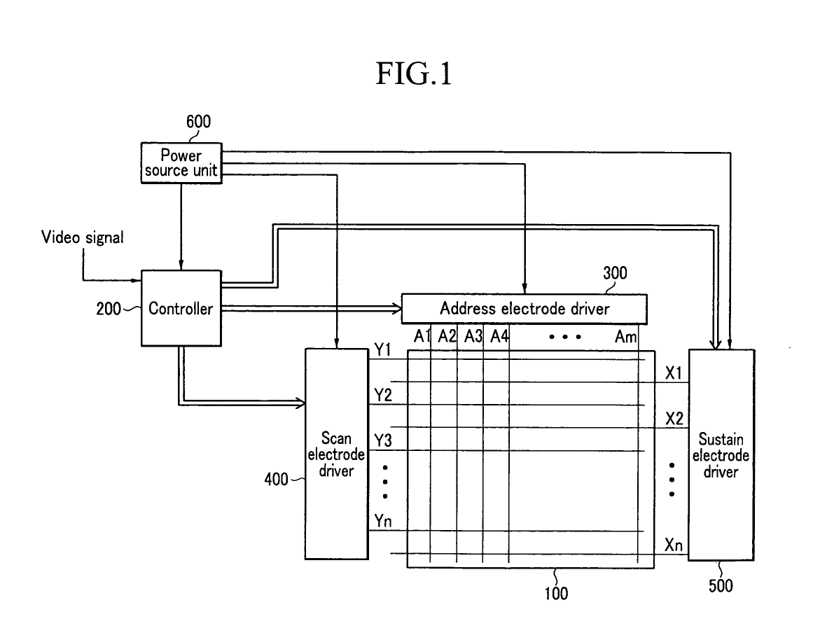

FIG. 1 is a schematic block diagram showing a plasma display device according to an exemplary embodiment of the present invention.

As shown in FIG. 1, the plasma display device according to the exemplary embodiment of the present invention includes a plasma display panel (PDP) 100, a controller 200, an address electrode driver 300, a scan electrode driver 400, and a sustain electrode driver 500.

The PDP 100 includes a plurality of address electrodes A1˜Am (referred to hereinafter as ‘A electrodes’) extending in a vertical direction and a plurality of sustain electrodes X1˜Xn (referred to hereinafter as ‘X electrodes’) and scan electrodes Y1˜Yn (referred to hereinafter as ‘Y electrodes’) extending in a horizontal direction. The X electrodes and the Y electrodes form pairs with each other. The sustain electrodes X1˜Xn are formed corresponding to the scan electrodes Y1˜Yn. In this case, a discharge space present at each crossing of the address electrodes A1˜Am, the sustain electrodes X1˜Xn, and the scan electrodes Y1˜Yn forms a discharge cell. The structure of the PDP 100 shows one example, and driving waveforms described hereinbelow according to embodiments of the present invention can also be applied to panels having different structures. Further, such panels having different structures may also be used in a plasma display according to embodiments of the present invention.

The controller 200 receives a video signal from outside and outputs an address electrode drive control signal, a sustain electrode drive control signal, and a scan electrode drive control signal. The controller 200 drives the PDP by dividing a single frame into a plurality of sub-fields each having a weight value. Gray levels are represented according to combination of the weight values of the sub-fields.

The address electrode driver 300 receives the address electrode drive control signals from the controller 200 and selectively applies address pulses for selecting cells to be turned on and cell not to be turned on during an address period to the address electrodes A1˜Am.

The scan electrode driver 400 receives the scan electrode drive control signal from the controller 200 and applies a driving voltage to the Y electrodes (Y1˜Yn). In particular, the scan electrode driver 400 selectively applies scan pulses to the plurality of scan electrodes Y1˜Yn during the address period. For example, the scan electrode driver 400 may sequentially apply the scan pulses in the order that the plurality of scan electrodes are arranged in the column direction.

The sustain electrode driver 500 receives a sustain electrode drive control signal from the controller and applies a driving voltage to the X electrodes X1˜Xn.

A power supply unit 600 supplies voltages required for driving the plasma display device to the controller 200 and the drivers 300, 400, and 500.

The driving waveforms of the plasma display device according to the exemplary embodiment of the present invention will now be described. Only the driving waveforms applied to the Y electrodes, X electrodes, and A electrodes that form a single cell will be described for the sake of convenience.

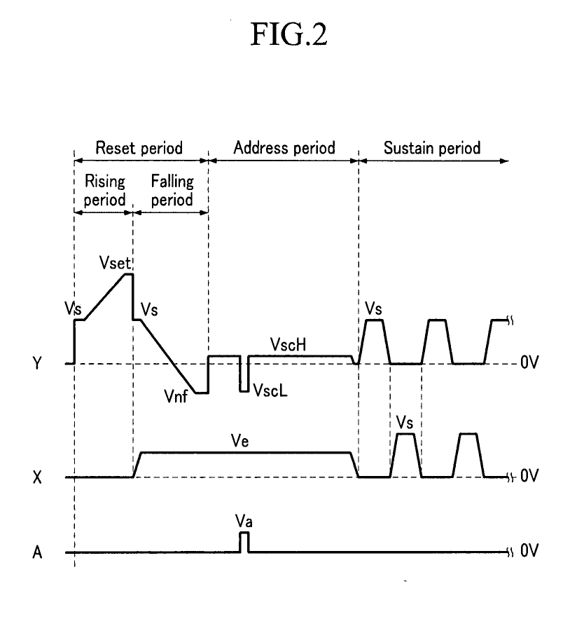

FIG. 2 is a waveform diagram illustrating driving waveforms of the plasma display device according to an exemplary embodiment of the present invention.

As shown in FIG. 2, during a rising period of a reset period, while the electrodes A and X are sustained at a reference voltage (e.g., indicated as 0V in FIG. 2), voltage of the Y electrodes gradually increases from voltage Vs and to voltage Vset. FIG. 2 shows the voltage of the electrodes Y which increases in a ramp pattern. While the voltage of the electrodes Y is increasing, a weak discharge occurs between the electrodes Y and X and between the electrodes Y and A, forming negative (−) wall charges in the electrodes Y and positive (+) wall charges in the electrodes X and A.

During a falling period of the reset period, while the electrodes A and X are sustained at the reference voltage and voltage Ve, respectively, the voltage of the electrodes Y gradually decreases from voltage Vs to voltage Vnf. Then, while the voltage of the electrodes Y is decreasing, a weak discharge occurs between the electrodes Y and X and between the electrodes Y and A, erasing the negative (−) wall charges formed in the electrode Y and the positive (+) wall charges formed in the electrodes X and A. In general, a size of the voltage (Vnf−Ve) is set near a discharge firing voltage Vfxy between the electrodes Y and X. Accordingly, a wall voltage between the electrodes Y and X becomes almost 0V, so that cells where an address discharge does not occur during the address period can be prevented from being erroneously discharged (misfiring) during a sustain period.

During the address period, in order to select discharge cells to be turned on, in a state that the voltage Ve is applied to the electrodes X, a scan pulse having a voltage VscL is sequentially applied to the plurality of electrodes Y. At this time, a voltage Va is applied to the electrodes A that pass through the discharge cells desired to be selected from the plurality of discharge cells to which the VscL voltage has been applied by the electrodes Y. Then, the address discharge occurs between the electrodes A to which the voltage Va has been applied and the electrodes Y to which the voltage VscL has been applied and between the electrodes Y to which the voltage VscL has been applied and the electrodes X to which the voltage Ve has been applied, forming the positive (+) wall charges in the electrodes Y and negative (−) wall charges in the electrodes A and X, respectively. Herein, the voltage VscL can be set to be the same as or lower than the voltage Vnf. Voltage VscH higher than the voltage VscL is applied to electrodes Y to which the voltage VscL is not applied, and the reference voltage is applied to the electrodes A which have not been selected.

During the sustain period, sustain discharge pulses that alternately have the voltages Vs and 0V at the electrodes Y and X are applied with the opposite phase to generate a sustain discharge between the electrodes Y and X. Thereafter, a process of applying the sustain discharge pulse of the voltage Vs to the electrodes Y and a process of applying the sustain discharge pulse of the voltage Vs to the electrodes X are repeatedly performed by the number corresponding to a weight value indicated by corresponding sub-fields.

In order to drive the plasma display device, a driving board for applying a driving voltage to each electrode and a plurality of power sources should be electrically connected. The power sources are connected with a capacitor, a capacitive load having large capacity, and the capacitor connected with the power sources is charged with a voltage supplied from the power sources. Thus, when a switch electrically connected with the power sources is turned on, voltage is provided from the capacitor connected with the power sources to the drivers.

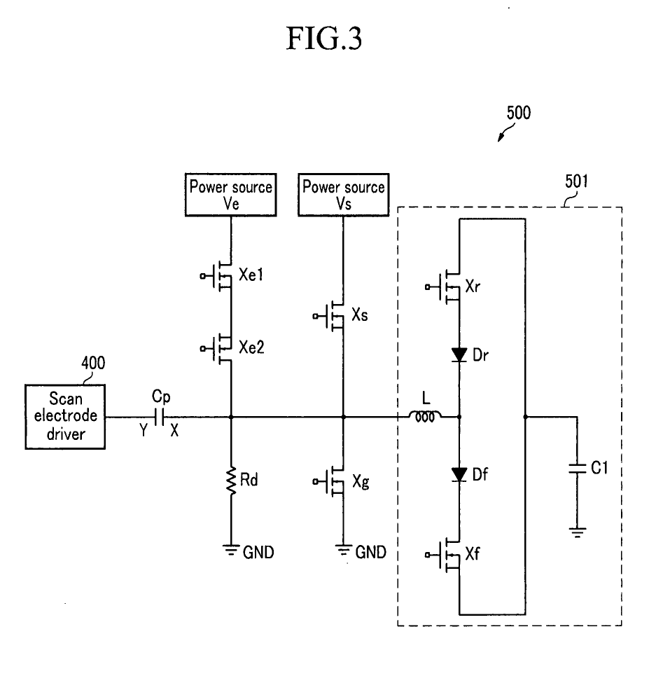

In the plasma display device and its driving method according to the exemplary embodiment of the present invention, a method for discharging the capacitor connected with the power sources after power of the plasma display device is turned off will now be described in detail with reference to FIGS. 3 to 6.

FIG. 3 is a circuit diagram of the sustain electrode driver 500 according to a first exemplary embodiment of the present invention. A transistor to be described hereinafter is an n-channel field effect transistor (FET) having a body diode (not shown), in which a first terminal of the body diode is connected with a first terminal of the transistor and an anode of the body diode is connected with a second terminal of the transistor. Such a transistor can be replaced by a switching element that has the same or similar function, and can be constructed using a plurality of transistors connected in parallel. In FIG. 3, a capacitive component formed by the electrodes X and Y is shown as a panel capacitor Cp. Some of the parts that are not necessary for a complete description of the exemplary embodiment of the present invention are omitted or schematically illustrated in FIGS. 3 to 6.

As shown in FIG. 3, the sustain electrode driver 500 includes a power recovery circuit 501, power sources Ve, Vs, and GND, transistors Xe1, Xe2, Xs, and Xg, and a discharge resistor Rd. A panel capacitor Cp is illustrated as being coupled between the sustain electrode driver 500 and the scan electrode driver 400.

The power recovery circuit 501 is constructed to re-use voltage of the panel capacitor Cp according to LC resonance. The power recovery circuit 501 is coupled with the power source Vs (via the transistor Xs) for supplying the voltage Vs and a power source GND (via the transistor Xg) for supplying 0V, and transistors Xs and Xg are connected between the power recovery circuit 501 and the power source Vs and between the power recovery circuit 501 and the power source GND, respectively. In addition, the power recovery circuit 501 includes a power recovery inductor L and a power recovery capacitor C1, and voltage having a level between 0V and the voltage Vs is charged in the power recovery capacitor C1. A first terminal of the capacitor C1 is coupled to the power recovery inductor L via a transistor Xr and a diode Dr. The first terminal of the capacitor C1 is also coupled to the power recovery inductor L via a diode Df and a transistor Xf. A second terminal of the capacitor C1 is connected to ground.

A first terminal of the transistor Xs is electrically connected with the power source Vs, and a second terminal of the transistor Xs is electrically connected with the panel capacitor Cp. A first terminal of the transistor Xg is electrically connected with the panel capacitor Cp and a second terminal thereof is connected with the power source GND.

During the sustain period, when the transistor Xs is turned on, the voltage Vs is applied to the panel capacitor Cp through a current path of the power source Vs through the transistor Xs to the panel capacitor Cp. When the transistor Xg is turned on, 0V is applied to the panel capacitor Cp through a current path of the power source GND through the transistor Xg to the panel capacitor Cp.

The transistors Xe1 and Xe2 are electrically connected between the power source Ve and the panel capacitor Cp. In one embodiment, the transistors Xe1 and Xe2 can be replaced by switching elements formed by connecting two transistors each having a body diode in a back-to-back manner.

When the transistors Xe1 and Xe2 are turned on at a point of time at which the falling period of the reset period starts, the voltage Ve is applied to the panel capacitor Cp through the current path of the power source Ve through the transistors Xe1 and Xe2 to the panel capacitor Cp.

The sustain electrode driver 500 further includes the discharge resistor Rd having one end connected with the panel capacitor Cp and the other end connected with the power source GND.

As shown in FIG. 3, the discharge resistor Rd is electrically connected between the panel capacitor Cp and the power source GND.

Discharging of the panel capacitor Cp by using the discharge resistor Rd will now be described.

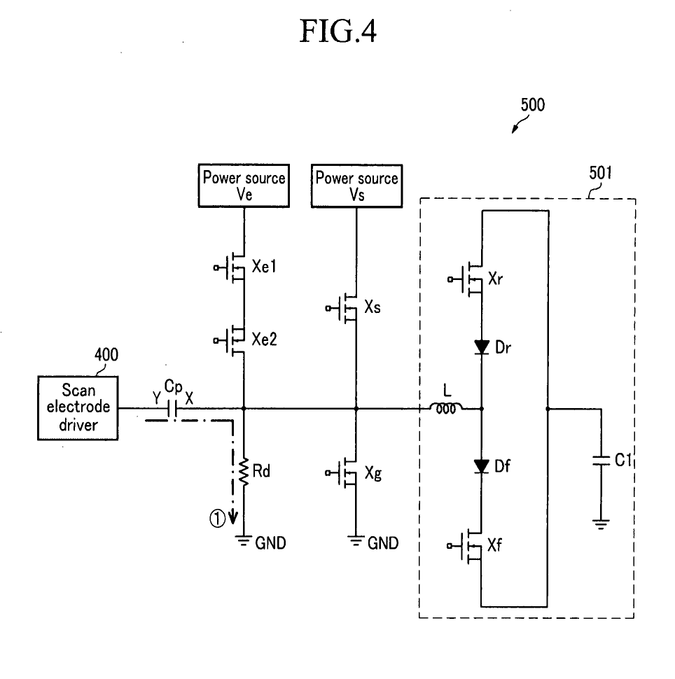

FIG. 4 is a circuit diagram showing a next driving operation of the driving circuit in FIG. 3 after power of the plasma display device is turned off according to the first exemplary embodiment of the present invention.

According to the first exemplary embodiment of the present invention, when power of the plasma display device is turned off, electric charges remaining in the panel capacitor Cp are discharged by using the discharge resistor Rd.

Namely, when driving of the plasma display device is terminated, the transistor Xs connected between the power source Vs and the sustain electrode is turned off, forming a current path \textcircled{1} of capacitor Cp through discharge resistor Rd to power source GND. Current corresponding to about Vs/Rd flows at the current path \textcircled{1}, so the electric charges remaining in the capacitor Cp are discharged to the power source GND by using the Rd resistor.

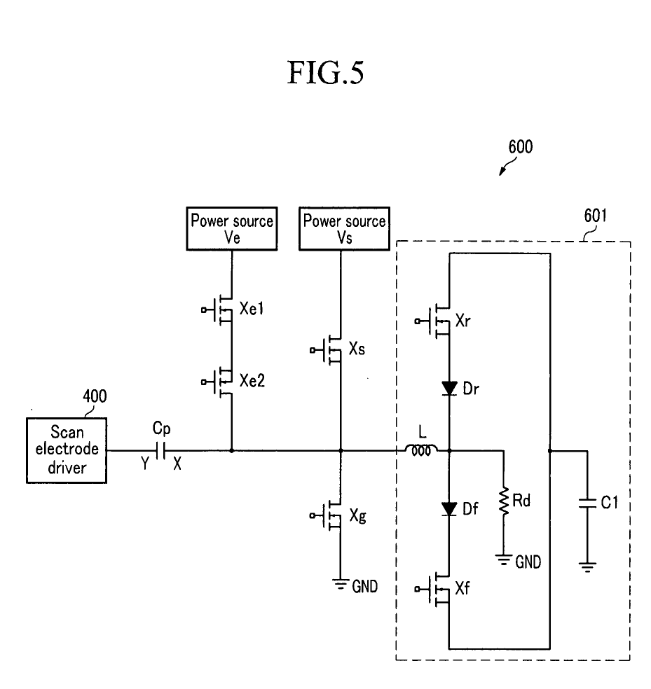

FIG. 5 is a circuit diagram of a sustain electrode driver 600 according to a second exemplary embodiment of the present invention. The sustain electrode driver 600, for example, can be used instead of the sustain electrode driver 500 in the plasma display device of FIG. 1, in one embodiment according to the present invention.

As shown in FIG. 5, the sustain electrode driver 600 includes a power recovery circuit 601, the power sources Ve, Vs, and GND, and transistors Xe1, Xe2, Xs, and Xg. Unlike the sustain electrode driver 500 of FIG. 3, the discharge resistor Rd is incorporated into the power recovery circuit 601. In the described embodiment, the discharge resistor Rd is connected between a power recovery inductor L and power source GND, which supplies the ground voltage.

The power recovery circuit 601 is constructed to re-use voltage of the panel capacitor Cp according to LC resonance. The power recovery circuit 601 is electrically connected with the power source Vs (via the transistor Xs) for supplying the voltage Vs and a power source GND (via the transistor Xg) for supplying 0V, respectively. The power recovery circuit 601 includes the power recovery inductor L, the power recovery capacitor C1, the transistors Xr and Xf, and the diodes Dr and Df. A first terminal of the inductor L is connected with a node where the transistors Xs and Xg meet, and a second terminal of the inductor L is commonly connected with a cathode of the diode Dr and an anode of the diode Df. A source electrode of the transistor Xr is connected with an anode of the diode Dr, and a drain electrode thereof is connected with a first terminal of the capacitor C1. In addition, a drain electrode of the transistor Xf is connected with a cathode of the diode Df, and also connected with the first terminal of the capacitor C1. A second terminal of the capacitor C1 is connected with a power source GND.

Accordingly, the power recovery circuit 601 uses the power recovery inductor L and the power recovery capacitor C1 to recover energy from the panel capacitor Cp., and a voltage having a level between 0V and the voltage Vs is charged in the power recovery capacitor C1.

A first terminal of the transistor Xs is electrically connected with the power source Vs and a second terminal thereof is connected with the panel capacitor Cp. A first terminal of the transistor Xg is electrically connected with the panel capacitor Cp and a second terminal thereof is connected with the power source GND.

During the sustain period, when the transistor Xs is turned on, the voltage Vs is applied to the panel capacitor Cp through a current path of the power source Vs through the transistor Xs to the panel capacitor Cp. When the transistor Xg is turned on, 0V is applied to the panel capacitor Cp through a current path of the power source GND through the transistor Xg to the panel capacitor Cp.

The transistors Xe1 and Xe2 are electrically connected between the power source Ve and the panel capacitor Cp. The transistors Xe1 and Xe2 can be replaced by switching elements formed by connecting two transistors each having a body diode in a back-to-back manner.

When the transistors Xe1 and Xe2 are turned on at a point of time at which the falling period of the reset period starts, the voltage Ve is applied to the panel capacitor Cp through a current path of the transistors Xe1 and Xe2 to the panel capacitor Cp.

The sustain electrode driver 600 includes the power recovery circuit 601, which includes the discharge resistor Rd having one end connected with the power recovery inductor L and a contact between the transistors Xr and Xf. In other words, the discharge resistor Rd is connected to the power recovery inductor L at a point or node between the cathode of the diode Dr and the anode of the diode Df.

Accordingly, as shown in FIG. 5, one end of the discharge resistor Rd is electrically connected with the power recovery inductor L and a contact between the transistors Xr and Xf (actually, between the diodes Dr and Df).

Discharging of the capacitor Cp by using the discharge resistor Rd will now be described.

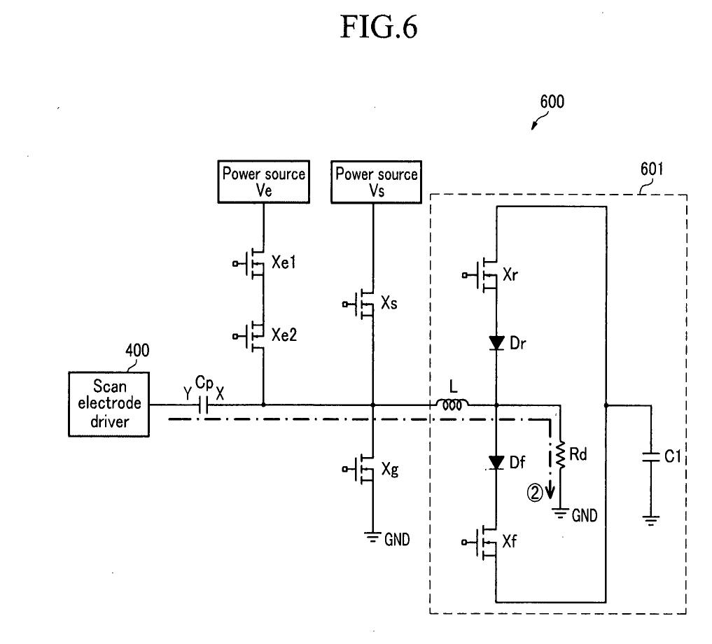

FIG. 6 is a circuit diagram illustrating a driving operation of the driving circuit in FIG. 5 after power of the plasma display device is turned off according to the second exemplary embodiment. First, according to the second exemplary embodiment of the present invention, when power of the plasma display device is turned off, electric charges remaining in the capacitor Cp are discharged by using the discharge resistor Rd. Namely, when power of the plasma display device is turned off, the transistor Xs connected between the power source Vs and the sustain electrode X is turned off, forming a current path \textcircled{2} of the panel capacitor Cp through the power recovery inductor L and the discharge resistor Rd to the power source GND, so the electric charges charged in the capacitor Cp are discharged to the power source GND by using the discharge resistor Rd.

Accordingly, in the plasma display device according to the exemplary embodiments of the present invention, by discharging the electric charges remaining after power of the plasma display device is turned off by using the discharge resistor, energy consumption and possible damage of elements (e.g., circuit components) can be reduced or prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

As described above, by using the discharge resistor Rd to discharge electric charges remaining in the panel capacitor Cp connected to the power source after power of the plasma display device is turned off, energy consumption and damage of elements can be prevented or reduced, and thus, reliability of the circuit can be improved.

What is claimed is:

1. A plasma display device comprising a plasma display panel (PDP) including a plurality of first and second electrodes, the plasma display device further comprising:
a first power source for supplying a first voltage;
a second power source for supplying a second voltage having a lower voltage level than the first voltage;
a third power source for supplying a third voltage;
a first transistor having a first terminal electrically connected with the plurality of first electrodes and a second terminal electrically connected with the first power source;
a second transistor having a first terminal electrically connected with the plurality of first electrodes and a second terminal electrically connected with the second power source; and
a resistor having a first end electrically connected with the plurality of first electrodes and a second end electrically connected with the third power source.

2. The plasma display device of claim 1, wherein the second and third power sources are electrically connected with each other, and the second and third voltages have substantially the same voltage level.

3. The plasma display device of claim 1, wherein when power of the plasma display device is turned off, a discharge path including the resistor is formed.

4. The plasma display device of claim 3, wherein when power of the plasma display device is turned off, the first and second transistors are turned off, and the first electrodes, the resistor and the third power source are electrically connected in series to form the discharge path.

5. The plasma display device of claim 1, wherein the first voltage has substantially the same voltage level as that of a sustain discharge pulse applied to the first electrodes during a sustain period.

6. The plasma display device of claim 1, further comprising:
a fourth power source for supplying a fourth voltage having a higher voltage level than the second voltage; and
a third transistor electrically connected between the fourth power source and the plurality of first electrodes.

7. The plasma display device of claim 6, wherein the third transistor comprises at least two transistors that are electrically connected in series between the fourth power source and the plurality of first electrodes.

8. The plasma display device of claim 6, wherein the fourth voltage has substantially the same voltage level as a bias voltage applied to the first electrodes during a falling period of a reset period and an address period.

9. The plasma display device of claim 1, wherein the second and third voltages are ground voltages.

10. A plasma display device comprising a plasma display panel (PDP) including a plurality of first and second electrodes, the plasma display device further comprising:
a first power source for supplying a first voltage;
a second power source for supplying a second voltage having a lower voltage level than the first voltage;
a third power source for supplying a third voltage;
a first transistor having a first terminal electrically connected with the plurality of first electrodes and a second terminal electrically connected with the first power source;
a second transistor having a first terminal electrically connected with the plurality of first electrodes and a second terminal electrically connected with the second power source;
an inductor having a first end electrically connected with the plurality of first electrodes; and
a resistor having a first end electrically connected with the inductor and a second end electrically connected with the third power source.

11. The plasma display panel of claim 10, wherein the second and third power sources are electrically connected with each other, and the second and third voltages have substantially the same voltage level.

12. The plasma display device of claim 10, wherein when power of the plasma display device is turned off, a discharge path including the resistor is formed.

13. The plasma display device of claim 12, wherein when power of the plasma display device is turned off, the first and second transistors are turned off, and the first electrodes, the inductor, the resistor and the third power source are electrically connected in series to form the discharge path.

14. The plasma display device of claim 10, wherein the first voltage has substantially the same voltage level as that of a sustain discharge pulse applied to the first electrodes during a sustain period.

15. The plasma display device of claim 10, further comprising:
a fourth power source for supplying a fourth voltage having a higher voltage level than the second voltage; and
a third transistor electrically connected between the fourth power source and the plurality of first electrodes.

16. The plasma display device of claim 15, wherein the fourth voltage has substantially the same voltage level as a bias voltage applied to the first electrodes during a falling period of a reset period and an address period.

17. The plasma display device of claim 10, further comprising:
a first diode electrically connected with a second end of the inductor and the first end of the resistor;
a second diode electrically connected with the second end of the inductor and the first end of the resistor;
a fourth transistor having a first terminal electrically connected with the first diode;
a fifth transistor having a second terminal electrically connected with the second diode;
a capacitor having a first terminal electrically connected with a second terminal of the fourth transistor and a first terminal of the fifth transistor; and
a fifth power source electrically connected with a second terminal of the capacitor, wherein the fifth power source is adapted to supply a fifth voltage.

18. The plasma display device of claim 17, wherein the second, third and fifth voltages are ground voltages.

19. A method for driving a plasma display device comprising a plurality of first electrodes, a plurality of second electrodes corresponding to the first electrodes, and a resistor having a first end electrically connected with the plurality of first electrodes and a second end electrically connected to a power source, the method comprising:
forming a discharge path through the first electrodes, the resistor, and the power source that are electrically connected after power of the plasma display device is turned off.

20. The method of claim 19, wherein the plasma display device further comprises an inductor electrically connected between the first electrodes and the resistor, and said forming a discharge path comprises: forming the discharge path through the first electrodes, the inductor, the resistor, and the power source that are electrically connected.
